(19) United States
(12) Patent Application Publication
(10) Pub. No.: US 2020/0320418 A1
(43) Pub. Date: Oct. 8, 2020

(54) System and Method for Third Party Data Management

(71) Applicant: Microsoft Technology Licensing, LLC, Redmond, WA (US)

(72) Inventors: Pouyan AMINIAN, Seattle, WA (US); Ashutosh Raghavender CHICKERUR, Sammamish, WA (US); Piyush JOSHI, Redmond, WA (US); Leili POURNASSEH, Bellevue, WA (US); Pradeep AYYAPPAN NAIR, Bellevue, WA (US)

(73) Assignee: Microsoft Technology Licensing, LLC, Redmond, WA (US)

(21) Appl. No.: 16/372,934

(22) Filed: Apr. 2, 2019

(51) Int. Cl. G06N 5/04; H04L 29/08; G06F 17/27; G06N 20/00

(52) U.S. Cl. CPC G06N 5/048; G06N 20/00; G06F 17/2785; H04L 67/26

(57) ABSTRACT

Described herein is a third party data management system that uses a classification algorithm trained using a machine learning process to analyze type(s) of data that will be shared with the third party to determine a risk of sharing data with the third party. Periodically data provided to a particular third party can be analyzed to identify privacy issue(s). In response to the analysis, an action to be taken with respect to the particular third party can be identified and provided to a user. In some embodiments, information from trusted news feeds can be processed using natural language processing to determine a potential privacy or security issue regarding a third party with whom data has been shared.

### BACKGROUND

Users are increasingly concerned with privacy of their digital information. In response to these concerns, governmental entities have promulgated data privacy regulations and laws.

### SUMMARY

Described herein is a third party data management system, comprising: a computer comprising a processor and a memory having computer-executable instructions stored thereupon which, when executed by the processor, cause the computer to: receive a request to add a third party for sharing of data; using a classification algorithm trained using a machine learning process, analyze one or more types of data that will be shared with the third party to determine a risk of sharing data with the third party; and provide information to a user regarding the determined risk of sharing data with the third party.

Also described herein is a method, comprising: using a classification algorithm trained using a machine learning process, periodically analyzing data provided to a particular third party to identify one or more privacy issues; in response to the analysis, identifying an action to be taken with respect to the particular third party; presenting information to a user regarding the identified action.

Further described herein is a computer storage media storing computer-readable instructions that when executed cause a computing device to: receive information from one or more trusted news feeds; using natural language processing, determine a potential privacy or security issue regarding a third party with whom data has been shared; and provide information to a user regarding the determined potential privacy or security issue regarding the third party.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a functional block diagram that illustrates a third party data management system.

FIG. 2 is a flow chart that illustrates a method of adding a third party for sharing of data.

FIG. 3 is a flow chart that illustrates a method of analyzing risk of sharing data with a third party.

FIG. 4 is a flow chart that illustrates a method of processing a user data request.

FIG. 5 is a flow chart that illustrates a method of monitoring a news feed.

FIG. 6 is a functional block diagram that illustrates an exemplary computing system.

### DETAILED DESCRIPTION

Various technologies pertaining to third party data management are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

The subject disclosure supports various products and processes that perform, or are configured to perform, various actions regarding third party data management. What follows are one or more exemplary systems and methods.

Aspects of the subject disclosure pertain to the technical problem of third party data management. The technical features associated with addressing this problem involve receiving a request to add a third party for sharing of data; using a classification algorithm trained using a machine learning process, analyzing one or more types of data that will be shared with the third party to determine a risk of sharing data with the third party; and, providing information to a user regarding the determined risk of sharing data with the third party. Accordingly, aspects of these technical features exhibit technical effects of more efficiently and effectively managing data of third party with whom data has been shared, for example, reducing computer resource consumption.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

As used herein, the terms “component” and “system,” as well as various forms thereof (e.g., components, systems, sub-systems, etc.) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers. Further, as used herein, the term “exemplary” is intended to mean serving as an illustration or example of something, and is not intended to indicate a preference.

Users are increasingly concerned with privacy of their digital information. In response to these concerns, governmental entities have promulgated data privacy regulations and laws. Some regulations may require tracking the flow of data into and out of an organization. In some instances, it may also be necessary to determine entities that have accessed certain types of data.

These data privacy regulations are subject to modification with the potential for additional data privacy regulations from various regulatory authorities throughout the world. Maintaining knowledge of the current data privacy regulations and an organization's possession of data as defined by the current privacy regulations can be a daunting task.

For example, the General Data Protection Regulation 2016/679 of the European Union (GDPR) sets forth privacy requirements on personal data shared between entities. This requires an entity subject to the GDPR know (a) what personal data the entity possesses; and (b) with whom the entity is sharing the personal data (e.g., sub processor(s)). Conventional data inventory software addresses internal of a particular entity; however, it does not address data sharing outside the boundaries of the particular entity.

In some instances, regulations imposed on organizations may impact the handling of data as it is used within an organization. The source of the data may be provided via an external source, which may originate from a third party outside the organization. Once data from an external source is introduced into a system, it may be desirable to understand information about the specific type of data possessed by the system as well as information about how certain types of data move within the system. In other cases, it may also be desirable to understand the specific uses of the data in the system.

Described herein is a third party data manager system and method that allows a privacy officer of an entity to inventory data sharing (e.g., anticipated or historical) with other entity(ies) (e.g., other organization(s) and/or company(ies)), sometimes referred to herein as “third party”. In some embodiments, “third party” refers to a natural or legal person, public authority, agency, and/or body other than the data subject, controller, processor and persons (e.g., entity) who, under the direct authority of the controller or processor, are authorized to process data (e.g., with whom the entity has shared and/or allowed access to data).

In some embodiments, “personal data” includes any information relating to an identified or identifiable natural person (“data subject”); an identifiable natural person is one who can be identified, directly or indirectly, in particular by reference to an identifier such as a name, an identification number, location data, an online identifier, and/or to one or more factors specific to the physical, physiological, genetic, mental, economic, cultural, and/or social identity of that natural person.

In some embodiments, the system can be integrated with the organization's purchasing systems and workflows to automatically inventory existing third party data sharing. In some embodiments, the system can be integrated with data inventory solutions to identify types of data that rests within the organization. Using machine learning based classification algorithm(s), the third party manager system can classify data into buckets based on their sensitivity (e.g., credit card data is very sensitive, user identification is somewhat sensitive, etc.) and calculate sensitivity scores using the classified data. These predicted sensitivity scores can be utilized by the privacy officer when assessing the risk of sharing a certain data type with a particular third party. This assessment can be performed at the commencement of a contractual relationship with a third party, periodically (e.g., monthly), periodically based upon assessed risk, and/or in response to user (e.g., compliance officer) request.

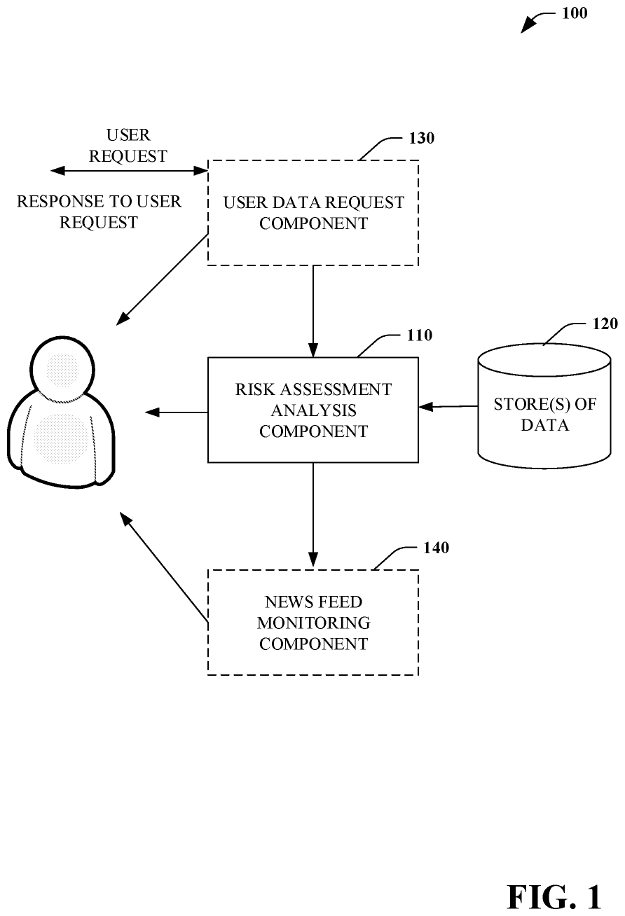

Referring to FIG. 1, a third party data management system 100 is illustrated. The system 100 can inventory data sharing with other entity(ies) (e.g., other organization(s) and/or company(ies)) and/or types of data that rests within the organization.

The system 100 can provide information to a user, such as a privacy officer, to assess the risk of sharing a certain data type with a particular third party. The system 100 can further periodically monitor data sharing with particular entity(ies) to determine whether changes in risk assessment (e.g., based upon changes in regulations, new regulations, and/or changes in data shared with the particular entity(ies)) have affected the assessed risk. The system 100 can provide information to the user regarding the changed risk assessment.

The system 100 includes a risk assessment analysis component 110 that provides information regarding a risk assessment of sharing of particular data and/or types of data with particular entity(ies). In some embodiments, the information regarding the risk assessment is an overall assessment with respect to previous shared data and/or anticipated data sharing (e.g., high, medium, or low). In some embodiments, the information regarding the risk assessment can be provided at a user-specified granular level, either initially and/or in response to a user request. In this manner, the user can be presented with information regarding risk of data sharing in each of a plurality of categories (e.g., highly sensitive data, personal data, anonymized personal data, etc.).

The risk assessment analysis component 110 can receive information, for example, from a user (e.g., compliance officer) identifying a third-party with whom data will be shared or has been shared. The risk assessment analysis component 110 can further receive information specifying source(s) of data 120 that will be shared and/or has been shared with the identified third-party.

In some embodiments, the information specifying source(s) of data 120 can be associated with a federated identity access system in which a single set of credentials (e.g., user name and password) allows a user access to particular web services. User names and passwords can have associated risk(s). In some embodiments, possession of user names and passwords by the identified third party can serve as a gateway to grant access to additional stored data (e.g., credit card number, passport number, etc.) which can have associated risk(s) that are the same, higher than, lower than, and/or different than the risk(s) associated with the user names and/or passwords.

Additionally, in some embodiments, the types of data shared with or accessible by the identified third party can be modified. For example, the credentials which originally only gave access to a user's first name and last name, can give access to a user's email address as a result of a change to the federated identity system. In some embodiments, the risk assessment analysis component 110 can periodically perform a risk assessment of one, some or all identified third-parties in order to provide current risk assessment information.

In some embodiments, with explicit or implicit consent, the data store(s) 120 include communication data, for example, emails, instant messages (IM), etc. between the organization and the identified third party. Consent to access the contents of communication between individual(s) associated with the organization can be set forth in an organization's policies (e.g., employment policy, employment agreement, contractor agreement). Additionally, contractual document(s) between the organization and the identified third party can specifically provide that electronic communications between individuals associated with the organization and the identified third party are subject to monitoring in order to determine risk assessment data of user data. For example, an IM between an individual associated with the organization and an individual associated with the third party can securely (encrypted) provide highly sensitive information (e.g., credit card number) outside expected data sharing channel(s). Identification of this single incident can significantly impact the risk assessment performed by the risk assessment component 110 and can impact the contractual relationship and/or communication behavior between individuals of the two entities.

For example, the risk assessment component 110 can alert the compliance officer to the incident and suggest that the contractual relationship be amended to include handling of highly sensitive data; and/or suggest that the individual from the organization be advised not to shared highly sensitive information with the identified third party.

In some embodiments, the risk assessment analysis component 110 utilizes classification algorithm(s) to classify the data that will be shared and/or has been shared with the identified third-party. In some embodiments, the classification algorithm(s) have been trained using a machine learning process that utilizes various features present in the data and/or types of data with the classification algorithm(s) representing an association among the features. In some embodiments, the classification algorithm is trained using one or more machine learning algorithms including linear regression algorithms, logistic regression algorithms, decision tree algorithms, support vector machine (SVM) algorithms, Naive Bayes algorithms, a K-nearest neighbors (KNN) algorithm, a K-means algorithm, a random forest algorithm, dimensionality reduction algorithms, Artificial Neural Network (ANN), and/or a Gradient Boost & Adaboost algorithm. The classification algorithm can be trained in a supervised, semi-supervised and/or unsupervised manner. In some embodiments, the classification algorithm(s) can be adaptively updated based, at least in part, upon a user's interaction with risk assessment information provided by the system 100.

In some embodiments, a particular classification algorithm can be trained to classify data in accordance with particular rule(s). For example, the particular rules(s) can be based, at least in part, upon contractual requirement(s), entity requirement(s), governmental requirement(s), temporal requirement(s), and/or geographical requirement(s). The particular rule(s) can set forth categories of data to be used in classifying the data to be shared and/or previously shared, and, the criteria for classifying data into each of the categories.

For example, a particular entity (e.g., corporation) can define a hierarchy of “highly sensitive data”, “sensitive data”, “minimally sensitive data”, and “non sensitive data”. “Highly sensitive data” can include credit card information. Thus, the classification algorithm of the risk assessment analysis component 110 can be trained to recognize credit card numbers present in data 120 and to classify that data as “highly sensitive data”.

For example, a particular rule can defined “personal data” as any information related to an individual that can be used to identify them directly or indirectly. The risk assessment analysis component 110 is calculating the risk of a personal data breach which is “a breach of security leading to the accidental or unlawful destruction, loss, alteration, unauthorized disclosure of, or access to, personal data transmitted, stored or otherwise processed.”

In some embodiments, the user can provide information regarding selection of one or more sets of rules to be utilized in classification of data. For example, the user can select one or more contractual requirement(s), one or more entity requirement(s), one or more governmental requirement(s), one or more temporal requirement(s), and/or one or more geographical requirement(s). In some embodiments, the risk assessment analysis component 110 can infer one or more sets of rules to be utilized in classification of data.

In some embodiments, the risk assessment analysis component 110 can be integrated with an organization's purchasing systems and workflows to automatically inventory existing third party data sharing. In some embodiments, the risk assessment analysis component 110 can be integrated with data inventory solutions to identify types of data that rests within the organization.

After reviewing a representative sample of data 120, substantially all the data 120, and/or all the data 120 to be shared and/or previously shared with the identified third-party, the risk assessment analysis component 110 can provide information to a user (e.g., compliance officer) relating to the risk of sharing data with the identified third party and/or with the data shared with the identified third party. In some embodiments, the information can be provided numerically, for example, on a scale of 1 to 100. In some embodiments, the information can be provided based upon pre-defined ranges (e.g., high, medium low).

In some embodiments, the risk assessment analysis component 120 can provide information regarding recommendation(s) to be taken with respect to the identified third-party. For example, a contractual agreement with the identified third-party can set forth obligations of the third party with respect to a classification of data that was expected to be shared with the identified third party (e.g., non-sensitive data). Upon reviewing the data 120 that has been shared with the identified third party, the risk assessment analysis component 120 determined that some highly sensitive data actually has been shared with the identified third-party. The risk assessment analysis component 120 can review existing contractual relationship(s) with the identified third party, if any, and recommend that the user consider amending the contractual agreement with the identified third-party to include obligations of the third party with respect to handling of highly sensitive data because highly sensitive data has been shared with the identified third party.

The system 100 can optionally further include a user data request component 130 that receives a request from a particular user with regard to data maintained by the organization, for example, stored in the data store 120. For example, the GDPR grants users a right to access data and a right to erasure (right to be forgotten). The user data request component 130 can utilize the risk assessment analysis component 110 to identify data stored in the data store(s) 120 responsive to the request. In some embodiments, the risk assessment analysis component 110 can further take action(s) in accordance with the request, for example, providing the requested information to the user request component 130 and/or deleting the requested information from the data store(s) 120 in compliance with the request and controlling regulation(s), if any.

The risk assessment analysis component 110 can further identify zero, one or more third-parties that the organization has allowed access to the data or shared data of the particular user. The risk assessment analysis component 110 can provide information regarding the identified third party(ies) to the user data request component 130 which can forward the request from the particular user directly to the identified third party(ies). The user data request component 130 can further monitor response(s) and/or lack thereof from the identified third party(ies) and provide information regarding response(s) and/or lack thereof to the compliance officer. For example, if an identified third party is contractually required to confirm receipt and action taken in response to a user request with a period of time (e.g., two hours), the user data request component 130 can provide information (e.g., displayed via user interface dashboard) to the compliance officer that the contractual requirement has or has not been met.

The system 100 can further optionally include a news feed monitoring component 140 that subscribes to one or more trusted news feeds to determine potential privacy or security issue(s) associated with one or more particular third party supplier (e.g., with whom the organization has contractual arrangements to share (provide) data). In some embodiments, the news feed monitoring component 140 can utilize a natural language processing to classify information received via the news feeds to determine likelihood (probability) that a privacy or security issue of a particular third party has occurred. For example, the news feed monitoring component 140 can identify third party(ies) associated with news content referencing “breach” or “leak” as potential privacy or security issues.

In some embodiments, the news feed monitoring component 140 can utilize an algorithm trained using a machine learning process that utilizes various features present in content of news feeds with the algorithm(s) representing an association among the features, as discussed above.

In some embodiments, the news feed monitoring component 140 can determine a risk assessment associated with the potential privacy or security issue. When the determined risk assessment is greater than a threshold, the news feed monitoring component 140 can initiate a process for minimizing privacy or security issue(s). In some embodiments, the news feed monitoring component 140 can prevent further data sharing with the third party. In some embodiments, the news feed monitoring component 140 can generate an alert and/or alarm to the compliance officer (e.g., displayed via the user interface dashboard).

In some embodiments, the system 100 can facilitate onboarding of a new supplier (third party) by an organization. The system 100 can provide risk assessment information regarding an analysis of the data and/or type of data expected to be shared (provided) to the new supplier. The information provided can allow the privacy officer to conduct a review to understand what data is being shared with the supplier. For example, the privacy officer can be presented with information regarding the data inventory and their associated sensitivity score. The privacy officer can also search for data store and data categories and see the sensitivity score for both. The supplier can then assigned either all data stores that will be shared with the supplier or, more broadly, all data categories that will be shared with the supplier. Based on the sensitivity, the system 100 can suggest additional contract term(s), for example, to be added to the Statement of Work or Master Service Agreement with the supplier. In some embodiments, the system 100 can auto-generates these terms from a database of boilerplate contracts. Moreover, the system 100 can recommend a recurrence for future reviews based on the nature of the data being shared with the supplier (e.g., monthly privacy reviews for very sensitive data, every 6 months for medium sensitivity etc.).

In some embodiments, the system 100 can provide information to the user (e.g., privacy officer) via a dashboard which provide information regarding third party(ies) pending review(s), upcoming periodic review(s), and/or result(s) of news feed monitoring.

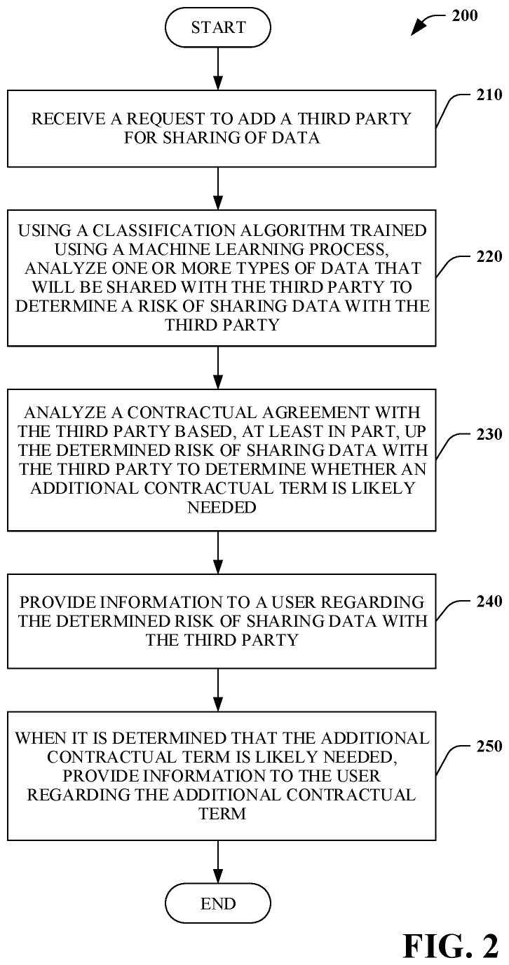

FIGS. 2-5 illustrate exemplary methodologies relating to third party data management. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring to FIG. 2, a method of adding a third party for sharing of data 200 is illustrated. In some embodiments, the method 200 is performed by the risk assessment analysis component 110.

At 210, a request to add a third party for sharing of data is received. At 220, a classification algorithm trained using a machine learning process is used to analyze one or more types of data that will be shared with the third party to determine a risk of sharing data with the third party. At 230, a contractual agreement with the third party is analyzed based, at least in part, up the determined risk of sharing data with the third party to determine whether an additional contractual term is likely needed.

At 240, information is provided to a user (e.g., compliance officer) regarding the determined risk of sharing data with the third party. At 250, when it is determined that the additional contractual term is likely needed, information is provided to the user regarding the additional contractual term.

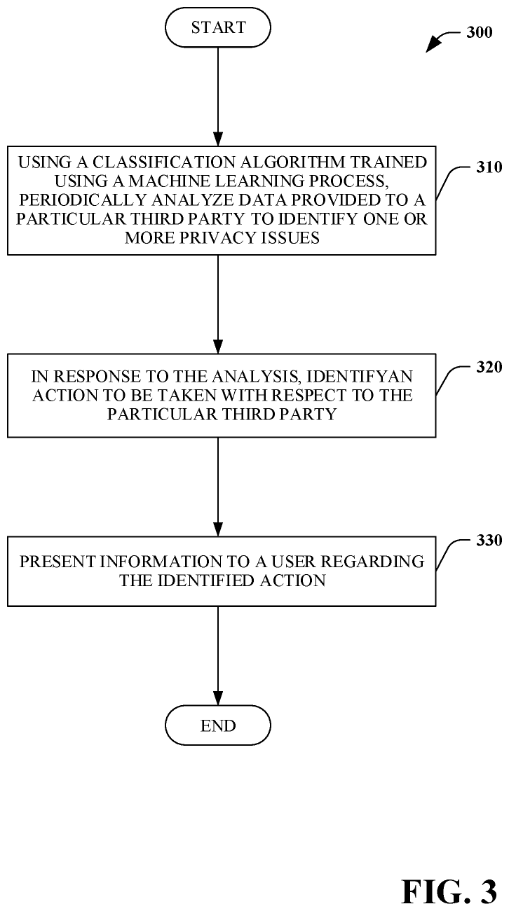

Turning to FIG. 3, a method of analyzing risk of sharing data with a third party 300 is illustrated. In some embodiments, the method 300 is performed by the risk assessment analysis component 110.

At 310, a classification algorithm trained using a machine learning process is used to periodically analyze data provided to a particular third party to identify one or more privacy issues. At 320, in response to the analysis, an action (e.g., an additional contract term) to be taken with respect to the particular third party is identified. At 330, information is provided to a user regarding the identified action.

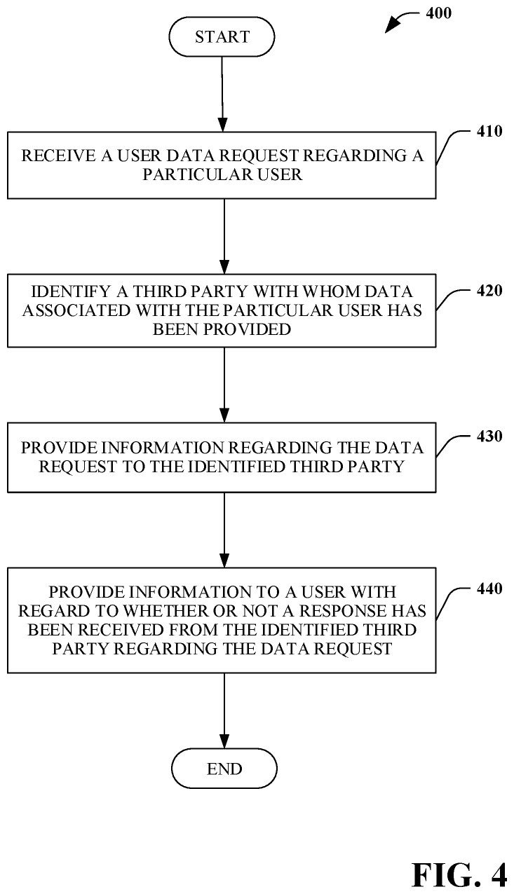

Next, referring to FIG. 4, a method of processing a user data request 400 is illustrated. In some embodiments, the method 400 is performed by the user data request component 130.

At 410, a user data request regarding a particular user is received. At 420, a third party with whom data associated with the particular user has been provided is identified. At 430, information regarding the data request is provided to the identified third party. At 440, information is provided to a user (e.g., compliant officer) with regard to whether or not a response has been received from the identified third party regarding the data request.

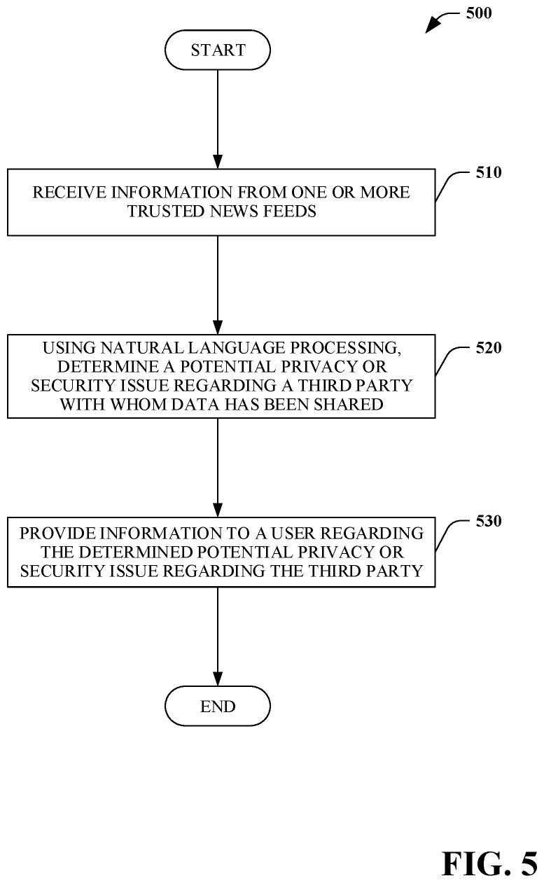

Turning to FIG. 5, a method of monitoring a news feed 500 is illustrated. In some embodiments, the method 500 is performed by the news feed monitoring component 140.

At 510, information is received from one or more trusted news feeds. At 520, using natural language processing, a potential privacy and/or security issue is identified regarding a third party with whom data has been shared. At 530, information is provided to a user regarding the determined potential privacy or security issue regarding the third party.

Described herein is a third party data management system, comprising: a computer comprising a processor and a memory having computer-executable instructions stored thereupon which, when executed by the processor, cause the computer to: receive a request to add a third party for sharing of data; using a classification algorithm trained using a machine learning process, analyze one or more types of data that will be shared with the third party to determine a risk of sharing data with the third party; and provide information to a user regarding the determined risk of sharing data with the third party.

The system can include the memory having further computer-executable instructions stored thereupon which, when executed by the processor, cause the computer to: analyze a contractual agreement with the third party based, at least in part, up the determined risk of sharing data with the third party to determine whether an additional contractual term is likely needed; and when it is determined that the additional contractual term is likely needed, provide information to the user regarding the additional contractual term.

The system can further include wherein the classification algorithm comprises at least one of a linear regression algorithm, a logistic regression algorithm, a decision tree algorithm, a support vector machine (SVM) algorithm, a Naive Bayes algorithm, a K-nearest neighbors (KNN) algorithm, a K-means algorithm, a random forest algorithm, a dimensionality reduction algorithm, an Artificial Neural Network, and/or a Gradient Boost & Adaboost algorithm.

The system can include the memory having further computer-executable instructions stored thereupon which, when executed by the processor, cause the computer to: train the classification algorithm using a machine learning process that utilizes various features present in at least one of the data or types of data with the classification algorithm representing an association among the features. The system can further include wherein the classification algorithm is trained in at least one of a supervised, semi-supervised, or unsupervised manner. The system can further include wherein the classification algorithm is adaptively updated based, at least in part, upon a user's interaction with the information provided to the user regarding the determined risk of sharing data with the third party.

The system can further include wherein the classification algorithm is trained to classify data in accordance with particular rules. The system can further include wherein the particular rules are based, at least in part, upon, at least one of a contractual requirement, an entity requirement, a governmental requirement, a temporal requirement, or a geographical requirement. The system can further include wherein the particular rules set forth a plurality of categories of data to be used by the classification algorithm, and, criteria for classifying data into each of the plurality of categories.

Described herein is a method, comprising: using a classification algorithm trained using a machine learning process, periodically analyzing data provided to a particular third party to identify one or more privacy issues; in response to the analysis, identifying an action to be taken with respect to the particular third party; presenting information to a user regarding the identified action.

The method can further include wherein the action comprises an additional contract term to be added to an existing contractual relationship with the particular third party. The method can further include wherein the classification algorithm comprises at least one of a linear regression algorithm, a logistic regression algorithm, a decision tree algorithm, a support vector machine (SVM) algorithm, a Naive Bayes algorithm, a K-nearest neighbors (KNN) algorithm, a K-means algorithm, a random forest algorithm, a dimensionality reduction algorithm, an Artificial Neural Network, and/or a Gradient Boost & Adaboost algorithm.

The method can further include training the classification algorithm using a machine learning process that utilizes various features present in at least one of the data or types of data with the classification algorithm representing an association among the features. The method can further include wherein the classification algorithm is trained in at least one of a supervised, semi-supervised, or unsupervised manner. The method can further include adaptively updating the classification algorithm based, at least in part, upon a user's interaction with the information provided to the user.

The method can further include wherein the classification algorithm is trained to classify data in accordance with particular rules. The method can further include wherein the particular rules are based, at least in part, upon, at least one of a contractual requirement, an entity requirement, a governmental requirement, a temporal requirement, or a geographical requirement. The method can further include wherein the particular rules set forth a plurality of categories of data to be used by the classification algorithm, and, criteria for classifying data into each of the plurality of categories.

Described herein is a computer storage media storing computer-readable instructions that when executed cause a computing device to: receive information from one or more trusted news feeds; using natural language processing, determine a potential privacy or security issue regarding a third party with whom data has been shared; and provide information to a user regarding the determined potential privacy or security issue regarding the third party.

The computer storage media can store further computer-readable instructions that when executed cause a computing device to: determine a risk assessment associated with the potential privacy or security issue; and when the determined risk assessment is greater than a threshold, initiate a process for preventing further data sharing with the third party.

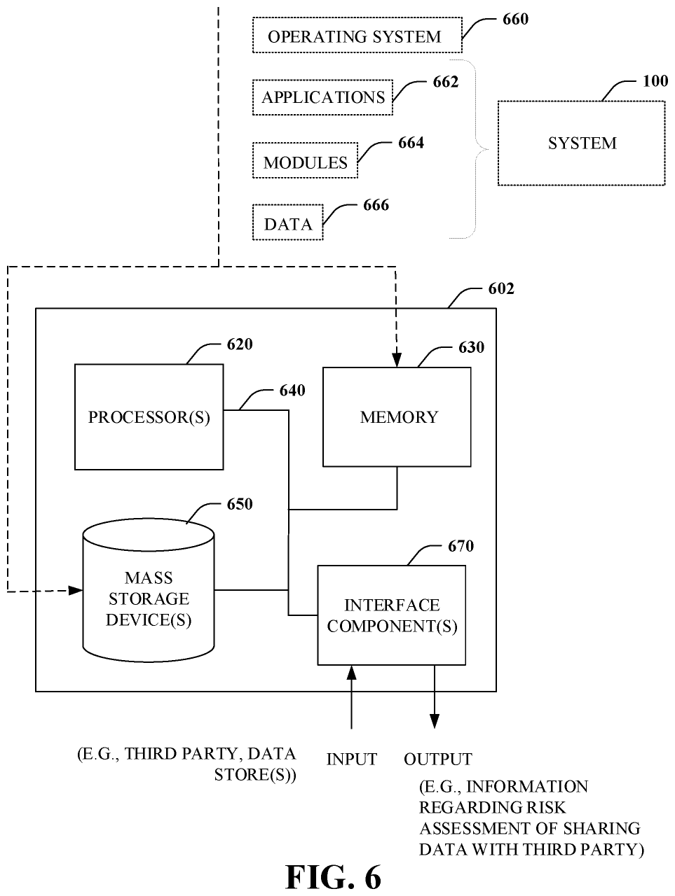

With reference to FIG. 6, illustrated is an example general-purpose computer or computing device 602 (e.g., mobile phone, desktop, laptop, tablet, watch, server, hand-held, programmable consumer or industrial electronics, set-top box, game system, compute node, etc.). For instance, the computing device 602 may be used in a third party data management system 100.

The computer 602 includes one or more processor(s) 620, memory 630, system bus 640, mass storage device(s) 650, and one or more interface components 670. The system bus 640 communicatively couples at least the above system constituents. However, it is to be appreciated that in its simplest form the computer 602 can include one or more processors 620 coupled to memory 630 that execute various computer executable actions, instructions, and or components stored in memory 630. The instructions may be, for instance, instructions for implementing functionality described as being carried out by one or more components discussed above or instructions for implementing one or more of the methods described above.

The processor(s) 620 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 620 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 620 can be a graphics processor.

The computer 602 can include or otherwise interact with a variety of computer-readable media to facilitate control of the computer 602 to implement one or more aspects of the claimed subject matter. The computer-readable media can be any available media that can be accessed by the computer 602 and includes volatile and nonvolatile media, and removable and non-removable media. Computer-readable media can comprise two distinct and mutually exclusive types, namely computer storage media and communication media.

Computer storage media includes volatile and nonvolatile, removable and non-removable media implemented in any method or technology for storage of information such as computer-readable instructions, data structures, program modules, or other data. Computer storage media includes storage devices such as memory devices (e.g., random access memory (RAM), read-only memory (ROM), electrically erasable programmable read-only memory (EEPROM), etc.), magnetic storage devices (e.g., hard disk, floppy disk, cassettes, tape, etc.), optical disks (e.g., compact disk (CD), digital versatile disk (DVD), etc.), and solid state devices (e.g., solid state drive (SSD), flash memory drive (e.g., card, stick, key drive) etc.), or any other like mediums that store, as opposed to transmit or communicate, the desired information accessible by the computer 602. Accordingly, computer storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Memory 630 and mass storage device(s) 650 are examples of computer-readable storage media. Depending on the exact configuration and type of computing device, memory 630 may be volatile (e.g., RAM), non-volatile (e.g., ROM, flash memory, etc.) or some combination of the two. By way of example, the basic input/output system (BIOS), including basic routines to transfer information between elements within the computer 602, such as during start-up, can be stored in nonvolatile memory, while volatile memory can act as external cache memory to facilitate processing by the processor(s) 620, among other things.

Mass storage device(s) 650 includes removable/non-removable, volatile/non-volatile computer storage media for storage of large amounts of data relative to the memory 630. For example, mass storage device(s) 650 includes, but is not limited to, one or more devices such as a magnetic or optical disk drive, floppy disk drive, flash memory, solid-state drive, or memory stick.

Memory 630 and mass storage device(s) 650 can include, or have stored therein, operating system 660, one or more applications 662, one or more program modules 664, and data 666. The operating system 660 acts to control and allocate resources of the computer 602. Applications 662 include one or both of system and application software and can exploit management of resources by the operating system 660 through program modules 664 and data 666 stored in memory 630 and/or mass storage device (s) 650 to perform one or more actions. Accordingly, applications 662 can turn a general-purpose computer 602 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, system 100 or portions thereof, can be, or form part, of an application 662, and include one or more modules 664 and data 666 stored in memory and/or mass storage device(s) 650 whose functionality can be realized when executed by one or more processor(s) 620.

In accordance with one particular embodiment, the processor(s) 620 can correspond to a system on a chip (SOC) or like architecture including, or in other words integrating, both hardware and software on a single integrated circuit substrate. Here, the processor(s) 620 can include one or more processors as well as memory at least similar to processor(s) 620 and memory 630, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the system 100 and/or associated functionality can be embedded within hardware in a SOC architecture.

The computer 602 also includes one or more interface components 670 that are communicatively coupled to the system bus 640 and facilitate interaction with the computer 602. By way of example, the interface component 670 can be a port (e.g., serial, parallel, PCMCIA, USB, FireWire, etc.) or an interface card (e.g., sound, video, etc.) or the like. In one example implementation, the interface component 670 can be embodied as a user input/output interface to enable a user to enter commands and information into the computer 602, for instance by way of one or more gestures or voice input, through one or more input devices (e.g., pointing device such as a mouse, trackball, stylus, touch pad, keyboard, microphone, joystick, game pad, satellite dish, scanner, camera, other computer, etc.). In another example implementation, the interface component 670 can be embodied as an output peripheral interface to supply output to displays (e.g., LCD, LED, plasma, etc.), speakers, printers, and/or other computers, among other things. Still further yet, the interface component 670 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A third party data management system, comprising:
a computer comprising a processor and a memory having computer-executable instructions stored thereupon which, when executed by the processor, cause the computer to:
receive a request to add a third party for sharing of data;
using a classification algorithm trained using a machine learning process, analyze one or more types of data that will be shared with the third party to determine a risk of sharing data with the third party; and
provide information to a user regarding the determined risk of sharing data with the third party.

2. The system of claim 1, the memory having computer-executable instructions stored thereupon which, when executed by the processor, cause the computer to:
analyze a contractual agreement with the third party based, at least in part, up the determined risk of sharing data with the third party to determine whether an additional contractual term is likely needed; and
when it is determined that the additional contractual term is likely needed, provide information to the user regarding the additional contractual term.

3. The system of claim 1, wherein the classification algorithm comprises at least one of a linear regression algorithm, a logistic regression algorithm, a decision tree algorithm, a support vector machine (SVM) algorithm, a Naive Bayes algorithm, a K-nearest neighbors (KNN) algorithm, a K-means algorithm, a random forest algorithm, a dimensionality reduction algorithm, an Artificial Neural Network, and/or a Gradient Boost & Adaboost algorithm.

4. The system of claim 1, the memory having computer-executable instructions stored thereupon which, when executed by the processor, cause the computer to:
train the classification algorithm using a machine learning process that utilizes various features present in at least one of the data or types of data with the classification algorithm representing an association among the features.

5. The system of claim 4, wherein the classification algorithm is trained in at least one of a supervised, semi-supervised, or unsupervised manner.

6. The system of claim 1, wherein the classification algorithm is adaptively updated based, at least in part, upon a user's interaction with the information provided to the user regarding the determined risk of sharing data with the third party.

7. The system of claim 1, wherein the classification algorithm is trained to classify data in accordance with particular rules.

8. The system of claim 7, wherein the particular rules are based, at least in part, upon, at least one of a contractual requirement, an entity requirement, a governmental requirement, a temporal requirement, or a geographical requirement.

9. The system of claim 7, wherein the particular rules set forth a plurality of categories of data to be used by the classification algorithm, and, criteria for classifying data into each of the plurality of categories.

10. A method, comprising:
using a classification algorithm trained using a machine learning process, periodically analyzing data provided to a particular third party to identify one or more privacy issues;
in response to the analysis, identifying an action to be taken with respect to the particular third party;
presenting information to a user regarding the identified action.

11. The method of claim 10, wherein the action comprises an additional contract term to be added to an existing contractual relationship with the particular third party.

12. The method of claim 10, wherein the classification algorithm comprises at least one of a linear regression algorithm, a logistic regression algorithm, a decision tree algorithm, a support vector machine (SVM) algorithm, a Naive Bayes algorithm, a K-nearest neighbors (KNN) algorithm, a K-means algorithm, a random forest algorithm, a dimensionality reduction algorithm, an Artificial Neural Network, and/or a Gradient Boost & Adaboost algorithm.

13. The method of claim 10, further comprising:
training the classification algorithm using a machine learning process that utilizes various features present in at least one of the data or types of data with the classification algorithm representing an association among the features.

14. The method of claim 13, wherein the classification algorithm is trained in at least one of a supervised, semi-supervised, or unsupervised manner.

15. The method of claim 10, further comprising:
adaptively updating the classification algorithm based, at least in part, upon a user's interaction with the information provided to the user.

16. The method of claim 10, wherein the classification algorithm is trained to classify data in accordance with particular rules.

17. The method of claim 16, wherein the particular rules are based, at least in part, upon, at least one of a contractual requirement, an entity requirement, a governmental requirement, a temporal requirement, or a geographical requirement.

18. The method of claim 16, wherein the particular rules set forth a plurality of categories of data to be used by the classification algorithm, and, criteria for classifying data into each of the plurality of categories.

19. A computer storage media storing computer-readable instructions that when executed cause a computing device to:
receive information from one or more trusted news feeds;
using natural language processing, determine a potential privacy or security issue regarding a third party with whom data has been shared; and
provide information to a user regarding the determined potential privacy or security issue regarding the third party.

20. The computer storage media of claim 19 storing further computer-readable instructions that when executed cause a computing device to:
determine a risk assessment associated with the potential privacy or security issue; and
when the determined risk assessment is greater than a threshold, initiate a process for preventing further data sharing with the third party.
